(19) United States
(12) Patent Application Publication
(10) Pub. No.: US 2014/0267130 A1
(43) Pub. Date: Sep. 18, 2014

(54) HOVER GESTURES FOR TOUCH-ENABLED DEVICES

(71) Applicant: MICROSOFT CORPORATION, Redmond, WA (US)

(72) Inventors: Daniel J. Hwang, Newcastle, WA (US); Sharath Viswanathan, Seattle, WA (US); Wenqi Shen, Bellevue, WA (US); Lynn Dai, Sammamish, WA (US)

(73) Assignee: Microsoft Corporation, Redmond, WA (US)

(21) Appl. No.: 13/801,665

(22) Filed: Mar. 13, 2013

(51) Int. Cl. G06F 3/0488

(52) U.S. Cl. CPC G06F 3/0488
USPC 345/174; 345/173

(57) ABSTRACT

Various embodiments herein provide for a method of receiving user input on a touch screen. A hover gesture can be detected and an action performed in response to the detection. The hover gesture can occur without a user physically touching a touch screen. Instead, the user's finger or fingers can be positioned at a spaced distance above the touch screen. The touch screen can detect that the user's fingers are proximate to the touch screen, such as through capacitive sensing. Additionally, finger movement can be detected while the fingers are hovering.

### BACKGROUND

Touch screens have had enormous growth in recent years. Touch screens are now common in places such as kiosks at airports, automatic teller machines (ATMs), vending machines, computers, mobile phones, etc.

The touch screens typically provide a user with a plurality of options through icons, and the user can select those icons to launch an application or obtain additional information associated with the icon. If the result of that selection did not provide the user with the desired result, then he/she must select a “back” button or “home” button or otherwise back out of the application or information. Such unnecessary reviewing of information costs the user time. Additionally, for mobile phone users, battery life is unnecessarily wasted.

Additionally, the library of touch gestures is limited. Well-known gestures include a flick, pan, pinch, etc., but new gestures have not been developed, which limits the functionality of a mobile device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments herein provide for a method of receiving user input on a touch screen. A hover gesture can be detected and an action performed in response to the detection. The hover gesture can occur without a user physically touching a touch screen. Instead, the user's finger or fingers can be positioned at a spaced distance above the touch screen. The touch screen can detect that the user's fingers are proximate to the touch screen, such as through capacitive sensing. Additionally, finger movement can be detected while the fingers are hovering to expand the existing options for gesture input.

The foregoing and other objects, features, and advantages of the invention will become more apparent from the following detailed description, which proceeds with reference to the accompanying figures.

### BRIEF DESCRIPTION OF THE DRAWINGS

FIG. 1 is a system diagram of an exemplary mobile device with a touchscreen for sensing a finger gesture.

FIG. 2 is an illustration of exemplary system components that can be used to receive finger-based hover input.

FIG. 3 is an example of displaying a missed call using a hover input.

FIG. 4 is an example of displaying a calendar event using a hover input.

FIG. 5 is an example of scrolling through different displays on a weather icon using a hover input.

FIG. 6 is an example of displaying additional information above the lock using a hover input.

FIG. 7 is an example of displaying a particular day on a calendar using a hover input.

FIG. 8 is an example of displaying a system settings page using a hover input.

FIG. 9 is an example of scrolling in a web browser using a hover input.

FIG. 10 is an example of highlighting text using a hover input.

FIG. 11 is an example of displaying a recent browsing page using the hover input.

FIG. 12 is an example of using a hover input in association with a map application.

FIG. 13 is an example of using hover input to zoom in a map application.

FIG. 14 is an example of using hover input to answer a phone call.

FIG. 15 is an example of displaying additional content associated with an icon using hover input.

FIG. 16 is an example of some of the hover input gestures that can be used.

FIG. 17 is a flowchart of a method for detecting and performing an action based on a hover gesture.

FIG. 18 is a flowchart of a method for detecting and performing an action based on a hover gesture.

FIG. 19 is a computer environment in which software can run to implement the embodiments described herein.

### DETAILED DESCRIPTION

Embodiments described herein focus on a mobile device, such as a mobile phone. However, the described embodiments can be applied to any device with a touch screen, including laptop computers, tablets, desktop computers, televisions, etc.

Hover Touch is built into the touch framework to detect a finger above-screen as well as to track finger movement. A gesture engine can be used for the recognition of hover touch gestures, including: (1) finger hover pan—float a finger above the screen and pan the finger in any direction; (2) finger hover tickle/flick—float a finger above the screen and quickly flick the finger as like a tickling motion with the finger; (3) finger hover circle—float a finger or thumb above the screen and draw a circle or counter-circle in the air; (4) finger hover hold—float a finger above the screen and keep the finger stationary; (5) palm swipe—float the edge of the hand or the palm of the hand and swipe across the screen; (6) air pinch/lift/drop—use the thumb and pointing finger to do a pinch gesture above the screen, drag, then a release motion; (7) hand wave gesture—float hand above the screen and move the hand back and forth in a hand-waving motion.

The hover gesture relates to a user-input command wherein the user's hand (e.g., one or more fingers, palm, etc.) is a spaced distance from the touch screen meaning that the user is not in contact with the touch screen. Moreover, the user's hand should be within a close range to the touch screen, such as between 0.1 to 0.25 inches, or between 0.25 inches and 0.5 inches, or between 0.5 inches and 0.75 inches or between 0.75 inches and 1 inch, or between 1 inch and 1.5 inches, etc. Any desired distance can be used, but generally such a distance can be less than 2 inches.

A variety of ranges can be used. The sensing of a user's hand can be based on capacitive sensing, but other techniques can be used, such as an ultrasonic distance sensor or camera-based sensing (images taken of user's hand to obtain distance and movement).

Once a hover touch gesture is recognized, certain actions can result, as further described below. Allowing for hover recognition significantly expands the library of available gestures to implement on a touch screen device.

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touchscreen 132, microphone 134, camera 136, physical keyboard 138 and/or trackball 140 and one or more output devices 150, such as a speaker 152 and a display 154. Touchscreens, such as touchscreen 132, can detect input in different ways. For example, capacitive touchscreens detect touch input when an object (e.g., a fingertip) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. For example, the touchscreen 132 can support a finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between .0.25 inches and 0.05 inches, or between .0.5 inches and 0.75 inches or between 0.75 inches and 1 inch, or between 1 inch and 1.5 inches, etc.

Other possible output devices (not shown) can include piezoelectric or other haptic output devices. Some devices can serve more than one input/output function. For example, touchscreen 132 and display 154 can be combined in a single input/output device. The input devices 130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 112 or applications 114 can comprise speech-recognition software as part of a voice user interface that allows a user to operate the device 100 via voice commands. Further, the device 100 can comprise input devices and software that allows for user interaction via a user's spatial gestures, such as detecting and interpreting gestures to provide input to a gaming application.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth 164 or Wi-Fi 162). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can be deleted and other components can be added.

FIG. 2 is a system diagram showing further details of components that can be used to implement a hover user input. A touch screen sensor 210 can detect a finger hover at a spaced distance (i.e., a non-zero distance) above the touch screen. Some examples of such technology are available from Cypress Semiconductor Corp.®, although other systems that provide similar detection functionality are known in the art. A gesture engine 212 can receive input from the touch screen sensor to interpret user input including one or more fingers in a hover position (a position at a distance above the touch screen) and a hover gesture (a user input command to perform an action). A hover gesture can include a user finger remaining in a fixed position for a predetermined period of time or some predetermined finger movement. Some predetermined finger movements can include a tickle movement, wherein the user moves his/her fingertip back and forth in a rapid motion to mimic tickling, or a circle movement, or a check movement (like a user is checking a box), etc. Specific gestures include, but are not limited to (1) finger hover pan—float a finger above the screen and pan the finger in any direction; (2) finger hover tickle/flick—float a finger above the screen and quickly flick the finger as like a tickling motion with the finger; (3) finger hover circle—float a finger or thumb above the screen and draw a circle or counter-circle in the air; (4) finger hover hold—float a finger above the screen and keep the finger stationary; (5) palm swipe—float the edge of the hand or the palm of the hand and swipe across the screen; (6) air pinch/lift/drop—use the thumb and pointing finger to do a pinch gesture above the screen, drag, then a release motion; (7) hand wave gesture—float hand above the screen and move the hand back and forth in a hand-waving motion. With each of these gestures, the user's fingers do not touch the screen.

Once the gesture engine interprets the gesture, the gesture engine 212 can alert an operating system 214 of the received gesture. In response, the operating system 214 can perform some action and display the results using a rendering engine 216.

FIG. 3 is an example of displaying a missed call using a hover input. As shown, a user's finger is spaced above a touch screen 310 by a non-zero distance 312 to represent a hover mode. In particular, the user's finger is placed above an icon 316 that indicates one or more calls were missed (e.g., an icon that indicates the number of missed calls, but not the callers associated with those calls). If the user leaves his/her finger in the same hover mode for a predetermined period of time (e.g., 1 second), then a hover gesture is detected, which is a user command to perform an action. In response, the icon dynamically changes as shown at 320 to display additional information about the missed call. If the person's name that called and his/her picture are in the phone's contacts list, the additional information can be a photo of the person, the name of the person, etc. If the user maintains the hover gesture, then multiple missed calls can be displayed one at a time in a round-robin fashion. Once the finger is removed, the icon returns to its previous state as shown at 316. Thus, a hover gesture can be detected in association with an icon and additional information can be temporarily displayed in association with the icon.

FIG. 4 is an example of displaying a calendar event using a hover gesture. As shown at 410, a hover mode is first entered when a user places his/her finger over an icon. The icon can be highlighted in response to entering the hover mode. If the user continues to maintain his/her finger in the hover mode for a predetermined period of time, then a hover gesture is detected. In response, a calendar panel is displayed at 420 showing the current days activities. The calendar panel can overlap other icons, such as a browser icon and a weather icon. Once the finger is removed, the panel 420 automatically disappears without requiring an additional user touch. Thus, a hover gesture can be detected in association with a calendar icon to display additional information stored in association with the calendar application. Example additional information can include calendar events associated with the current day.

FIG. 5 is an example of interacting with an application icon 510. The illustrated application is a weather application. If a hover gesture is detected, then the application icon dynamically cycles through different information. For example, the application icon 510 can dynamically be updated to display Portland weather 512, then Seattle weather 514, then San Francisco weather 516, and repeat the same. Once the user's finger is removed, the icon ceases to cycle through the different weather panels. Thus, a hover gesture can be detected in association with a weather application to show additional information about the weather, such as the weather in different cities.

FIG. 6 shows an example of displaying additional information on a lock screen above the lock using a hover input. As shown at 610, at least one user finger is detected in a hover position, the finger being at a spaced distance (i.e., non-zero) from the touch screen. The touch screen is displaying that there is a message to be viewed, and the user's finger is hovering above the message indication. If the user performs a hover gesture, then the message is displayed over the lock screen as shown at 612 in a message window. The hover gesture can be simply maintaining the user's finger in a fixed position for a predetermined period of time. Once the user's finger is removed (i.e., further than a predetermined distance from the message indication), then the message window is removed. Although a message indication is shown for an above-lock function, other indications can also be used, such as new email indications (hover and display one or more emails), calendar items (hover to display more information about a calendar item), social networking notifications (hover to see more information about the notification), etc.

FIG. 7 is an example of displaying a particular day on a calendar application using a hover gesture. At 710, a calendar application is shown with a user performing a hover command above a particular day in a monthly calendar. As a result, the detailed agenda for that day is displayed overlaying or replacing the monthly calendar view, as shown at 712. Once the user's finger is removed from the hover position, the monthly calendar view 710 is again displayed. Another hover gesture that can be used with a calendar is to move forward or backward in time, such as by using an air swiping hover gesture wherein the user's entire hand hovers above the touch screen and moves right, left, up or down. In a day view, such a swiping gesture can move to the next day or previous day, to the next week or previous week, and so forth. In any event, a user can perform a hover command to view additional detailed information that supplements a more general calendar view. And, once the user discontinues the hover gesture, the detailed information is removed and the more general calendar view remains displayed.

FIG. 8 is an example of displaying a system settings page using a hover gesture. From any displayed page, the user can move his/her hand into a hover position and perform a hover gesture near the system tray 810 (a designated area on the touch screen). In response, a system setting page 812 can be displayed. If the user removes his/her finger, then the screen returns to its previously displayed information. Thus, a user can perform a hover gesture to obtain system settings information.

FIG. 9 is an example of scrolling in a web browser using a hover gesture. A web page is displayed, and a user places his/her finger at a predetermined position, such as is shown at 910, and performs a hover gesture. In response, the web browser automatically scrolls to a predetermined point in the web page, such as to a top of the web page, as is shown at 920. Alternatively, the scrolling can be controlled by a hover gesture, such as scrolling at a predetermined rate and in a predetermined direction.

FIG. 10 is an example of selecting text using a hover input. As shown at 1010, a user can perform a hover gesture above text on a web page. In response, a sentence being pointed at by the user's finger is selected, as shown at 1012. Once selected, additional operations can be performed, such as copy, paste, cut, etc. Thus, a hover gesture can be used to select text for copying, pasting, cutting, etc.

FIG. 11 is an example of displaying a list of recently browsed pages using the hover input. A predetermined hover position on any web page can be used to display a list of recently visited websites. For example, at 1110, a user can perform a hover gesture at a bottom corner of a webpage in order to display a list of recently visited sites, such as is shown at 1120. The user can either select one of the sites or remove his/her finger to return to the previous web page. Thus, the hover command can be used to view recent history information associated with an application.

FIG. 12 is an example of using a hover gesture in association with a map application. At 1210, a user performs a hover gesture over a particular location or point of interest on a displayed map. In response, a pane 1220 is displayed that provides additional data about the location or point of interest to which the user points. As in all of the above examples, if the user moves his/her finger away from the touch screen, then the map 1210 returns to being viewed, without the user needing to touch the touch screen. Thus, a hover gesture can be used to display additional information regarding an area of the map above which the user is hovering. Furthermore, FIG. 12 illustrates that when content is being displayed in a page mode, the user can perform a hover command above any desired portion of the page to obtain further information.

FIG. 13 is an example of using hover input to zoom in a map application. At 1310, a mobile device is shown with a map being displayed using a map application. As shown at 1312, a user performs a hover gesture, shown as a clockwise circle gesture around an area into which a zoom is desired. The result is shown at 1320 wherein the map application automatically zooms in response to receipt of the hover gesture. Zooming out can also be performed using a gesture, such as a counterclockwise circle gesture. The particular gesture is a matter of design choice. However, a user can perform a hover gesture to zoom in and out of a map application.

FIG. 14 is an example of using hover input to answer a phone call. If a user is driving and does not want to take his/her eyes off of the road to answer a phone call, the user can perform a hover gesture, such as waving a hand above the touch screen as indicated at 1410. In response, the phone call is automatically answered, as indicated at 1420. In one example, the automatic answering can be to automatically place the phone is a speakerphone mode, without any further action by the user. Thus, a user gesture can be used to answer a mobile device after a ringing event occurs.

FIG. 15 is an example of displaying additional content associated with an icon using a hover gesture. At 1510, a user performs a hover gesture over an icon on a mobile device. In response, as shown at 1520, additional content is displayed associated with the icon. For example, the icon can be associated with a musical artist and the content can provide additional information about the artist.

FIG. 16 provides examples of different hover gestures that can be used. A first hover gesture 1610 is a circle gesture wherein the user's finger moves in a circular motion. Clockwise circle gestures can be interpreted as different than counterclockwise gestures. For example, a counterclockwise circular gesture can be interpreted as doing an opposite of the clockwise circular gesture (e.g., zoom in and zoom out). A second hover gesture 1620 is shown as a tickle motion wherein a user's fingertip moves in a back-and-forth motion. Although not shown in FIG. 16, a third hover gesture is where a user's pointer finger is maintained in the same hover position for more than a predetermined period of time. Other hover gestures can be used, such as a user tracing out a check mark over the screen, for example. In any event, multiple of the hover gestures detect a predefined finger motion at a spaced distance from the touch screen. Other hover gestures can be a quick move in and out without touching the screen. Thus, the user's finger enters and exits a hover zone within a predetermined time period. Another hover gesture can be a high-velocity flick, which is a finger traveling at a certain minimal velocity over a distance. Still another hover gesture is a palm-based wave gesture.

Other example applications of the hover gesture can include having UI elements appear in response to the hover gesture, similar to a mouse-over user input. Thus, menu options can appear, related contextual data surfaced, etc. In another example, in a multi-tab application, a user can navigate between tabs using a hover gesture, such as swiping his or her hand. Other examples include focusing on an object using a camera in response to a hover gesture, or bringing camera options onto the UI (e.g., flash, video mode, lenses, etc.) The hover command can also be applied above capacitive buttons to perform different functions, such as switching tasks. For example, if a user hovers over a back capacitive button, the operating system can switch to a task switching view. The hover gesture can also be used to move between active phone conversations or bring up controls (fast forward, rewind, etc.) when playing a movie or music. In still other examples, a user can air swipe using an open palm hover gesture to navigate between open tabs, such as in a browser application. In still other examples, a user can hover over an entity (name, place, day, number, etc.) to surface the appropriate content inline, such as displaying addition information inline within an email. Still further, in a list view of multiple emails, a hover gesture can be used to display additional information about a particular email in the list. Further, in email list mode, a user can perform a gesture to delete the email or display different action buttons (forward, reply, delete). Still further, a hover gesture can be used to display further information in a text message, such as emoji in a text message. In messaging, hover gestures, such as air swipes can be used to navigate between active conversations, or preview more lines of a thread. In videos or music, hover gestures can be used to drag sliders to skip to a desired point, pause, play, navigate, etc. In terms of phone calls, hover gestures can be used to display a dialog box to text a sender, or hover over an “ignore” button to send a reminder to call back. Additionally, a hover command can be used to place a call on silent. Still further, a user can perform a hover gesture to navigate through photos in a photo gallery. Hover commands can also be used to modify a keyboard, such as changing a mobile device between left-handed and right-handed keyboards. As previously described, hover gestures can also be used to see additional information in relation to an icon.

FIG. 17 is a flowchart of an embodiment for receiving user input on a touch screen. In process block 1710, at least one finger or other portion of a user's hand is detected in a hover position. A hover position is where one or more fingers are detected above the touch screen by a spaced distance (which can be any distance whether it be predetermined or based on reception of a signal), but without physically touching the touch screen. Detection means that the touch sensor recognizes that one or more fingers are near the touch screen. In process block 1720, a hover gesture is detected. Different hover gestures were already described above, such as a circle gesture, hold gesture, tickle gesture, etc. In process block 1730, an action is performed based on the hover gesture. Any desired action can occur, such as displaying additional information (e.g., content) associated with an icon, displaying calendar items, automatic scrolling, etc. Typically, the additional information is displayed in a temporary pop-up window or sub-window or panel, which closes once the touch screen no longer detects the user's finger in the hover position.

FIG. 18 is a flowchart of a method according to another embodiment. In process block 1810, a hover mode is entered when a finger is detected in a hover position at a spaced distance from the touch screen. In some embodiments, once the hover mode is entered, then hover gestures can be received. In process block 1820, a hover gesture is detected indicating that a user wants an action to be performed. Example actions have already been described herein. In process block 1830, the hover gesture is interpreted as a user input command, which is performed to carry out the user's request.

FIG. 19 depicts a generalized example of a suitable computing environment 1900 in which the described innovations may be implemented. The computing environment 1900 is not intended to suggest any limitation as to scope of use or functionality, as the innovations may be implemented in diverse general-purpose or special-purpose computing systems. For example, the computing environment 1900 can be any of a variety of computing devices (e.g., desktop computer, laptop computer, server computer, tablet computer, media player, gaming system, mobile device, etc.)

With reference to FIG. 19, the computing environment 1900 includes one or more processing units 1910, 1915 and memory 1920, 1925. In FIG. 19, this basic configuration 1930 is included within a dashed line. The processing units 1910, 1915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 19 shows a central processing unit 1910 as well as a graphics processing unit or co-processing unit 1915. The tangible memory 1920, 1925 may be volatile memory (e.g., registers, cache, RAM), nonvolatile memory (e.g., ROM, EEPROM, flash memory, etc.), or some combination of the two, accessible by the processing unit(s). The memory 1920, 1925 stores software 1980 implementing one or more innovations described herein, in the form of computer-executable instructions suitable for execution by the processing unit(s).

A computing system may have additional features. For example, the computing environment 1900 includes storage 1940, one or more input devices 1950, one or more output devices 1960, and one or more communication connections 1970. An interconnection mechanism (not shown) such as a bus, controller, or network interconnects the components of the computing environment 1900. Typically, operating system software (not shown) provides an operating environment for other software executing in the computing environment 1900, and coordinates activities of the components of the computing environment 1900.

The tangible storage 1940 may be removable or non-removable, and includes magnetic disks, magnetic tapes or cassettes, CD-ROMs, DVDs, or any other medium which can be used to store information which can be accessed within the computing environment 1900. The storage 1940 stores instructions for the software 1980 implementing one or more innovations described herein.

The input device(s) 1950 may be a touch input device such as a touchscreen, keyboard, mouse, pen, or trackball, a voice input device, a scanning device, or another device that provides input to the computing environment 1900. For video encoding, the input device(s) 1950 may be a camera, video card, TV tuner card, or similar device that accepts video input in analog or digital form, or a CD-ROM or CD-RW that reads video samples into the computing environment 1900. The output device(s) 1960 may be a display, printer, speaker, CD-writer, or another device that provides output from the computing environment 1900.

The communication connection(s) 1970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

1. A method of receiving user input on a touch screen, comprising:
detecting at least one finger in a hover position, wherein the at least one finger is a spaced distance from the touch screen;
detecting a hover gesture, which is a user command to perform an action, wherein the hover gesture occurs without touching the touch screen; and
performing the action based on the hover gesture.

2. The method of claim 1, wherein the hover gesture is a finger tickle.

3. The method of claim 1, wherein the hover gesture is circle gesture.

4. The method of claim 1, wherein the hover gesture is a holding of the finger in a fixed position for at least a predetermined period of time.

5. The method of claim 1, wherein the detecting of the at least one finger in the hover position includes associating the finger position with an icon displayed on the touch screen.

6. The method of claim 5, wherein the action includes displaying additional information associated with the icon.

7. The method of claim 6, wherein the icon is associated with a list of recent calls, and the action includes displaying additional details associated with at least one missed call.

8. The method of claim 1, wherein the touch screen is on a mobile phone.

9. The method of claim 5, wherein the icon is associated with a calendar and the action includes displaying calendar items for a current day.

10. The method of claim 1, wherein the action includes displaying additional information in a sub-window until it is detected that the at least one finger is no longer in the hover position.

11. The method of claim 1, wherein the touch screen is in a first state and, in response to the action, enters a second state wherein a pop-up window is displayed until the finger moves from the hover position.

12. The method of claim 1, wherein the action includes automatically scrolling to a predetermined point in a document.

13. A computer readable storage medium for storing instructions thereon for executing a method of receiving user input on a touch screen, the method comprising:
entering a hover mode wherein a finger is detected in a hover position at a spaced distance from the touch screen;
detecting a hover gesture indicating that the user wants an action to be performed, wherein the hover gesture occurs without touching the touch screen; and
performing a user input command based on the hover gesture.

14. The computer readable medium of claim 13, wherein the hover gesture includes a finger motion.

15. The computer readable medium of claim 13, the detecting of the at least one finger in the hover position includes associating the finger position with an icon displayed on the touch screen.

16. The computer readable medium of claim 15, wherein the action includes displaying additional information associated with the icon.

17. The computer readable medium of claim 13, wherein the touch screen is on a mobile phone.

18. The computer readable medium of claim 15, wherein the icon is associated with a calendar and the action includes displaying calendar items for a current day.

19. An apparatus for receiving user input, comprising:
a touch screen that uses capacitive sensing to detect a hover position and a hover gesture, wherein a finger is detected at a spaced distance from the touch screen;
a gesture engine that interprets input from the touch screen; and
a rendering engine that displays information in response to the hover position and the hover gesture.

20. The apparatus of claim 19, further including an operating system that receives user input associated with the hover position or the hover gesture from the gesture engine and that decides an action to take in response to the hover position or the hover gesture.
